(19) United States
(12) Patent Application Publication
(10) Pub. No.: US 2003/0196334 A1
(43) Pub. Date: Oct. 23, 2003

(54) Sod-cutting tool

(76) Inventor: Robert L. Finney, West Des Moines, IA (US)

Correspondence Address: MERCHANT & GOULD PC, P.O. BOX 2903, MINNEAPOLIS, MN, 55402-0903, US

(21) Appl. No.: 10/127,964

(22) Filed: Apr. 22, 2002

(51) Int. Cl. B26B 27/00

(52) U.S. Cl. 30/300; 30/310; 30/316

(57) ABSTRACT

Devices for cutting sod around sprinkler heads. The device may include a handle coupled to a shaft. The shaft may be coupled to a cylindrical cutting assembly that includes one or more blades that are inserted into sod that has grown over a sprinkler head. The cutting assembly is rotated to cut the sod. Alternatively, a cylindrical cutting assembly may be coupled to a drive motor that mechanically lowers the cylindrical cutting assembly into the sod and rotates the cylindrical cutting assembly to cut the sod growing over the sprinkler head.

### FIELD OF THE INVENTION

The present invention relates to devices for cutting sod. More particularly, the invention relates to a device that cuts sod, where the sod may restrict a sprinkler head.

### BACKGROUND OF THE INVENTION

Golf has become a popular leisure sport that has created an increased demand for highly maintained golf courses. One of the most significant attributes of a golf course is its physical appearance. Therefore, it has become important for course owners to invest substantial time and effort in the maintenance of the grounds. In order to keep the greens, fairways, and rough in their best condition, most modern golf courses include underground sprinkler systems that water these areas on a regular basis. A typical underground sprinkler system includes underground pipes that transport water to sprinkler heads that are strategically distributed throughout the course. During operation of the sprinkler system, the sprinkler heads move from a position recessed just below the surface of the sod to a position where the water can be distributed to a desired area. The sod surrounding the sprinkler heads may grow at a faster rate because these areas receive the most significant amounts of moisture. This growth, by passing up and over the face of the sprinkler heads, may restrict or block the operation of the sprinkler heads. In such a situation, the sod prohibits the sprinkler head from extending to its proper position above the grass surface. This leaves some areas susceptible to inadequate watering and drought conditions.

In order to remove overgrown sod from around sprinkler heads, grounds keepers have typically used conventional line trimmers. This often leaves the sod with a ragged appearance that is not visually appealing. Further, line trimmers may not adequately remove all of the restrictive sod. The grounds keeper then has to remove the overgrowth manually with a knife or small shovel. This not only requires additional time, but also exposes a grounds keeper to potential back injury.

The aesthetically appealing and easy removal of sod from around or over sprinkler heads is important to provide effective maintenance to a golf course or other area that includes an underground sprinkler system. Therefore, it is desirable to provide a device that aids in the quick, complete and clean removal of overgrown sod from sprinkler heads.

### SUMMARY OF THE INVENTION

Generally, the present invention relates to a tool for the cutting of sod. More particularly, the invention relates to a device that cuts sod that has grown over a sprinkler head.

In one aspect, the invention relates to a device for manually cutting sod around a sprinkler head including a shaft having a first end and second end, a handle coupled to the first end of the shaft, and a cutting assembly coupled to the second end of the shaft through a linkage assembly. The cutting assembly includes a cylinder and a blade configured to cut sod and wherein the linkage assembly regulates a depth of cutting into the sod.

In another aspect, the invention relates to a device for manually cutting sod around a sprinkler head including a shaft having a first end and a second end, a handle coupled to the first end of the shaft, and a cylindrical blade coupled to the second end of the shaft to cut sod wherein the cylindrical blade includes a serrated bottom edge.

In another aspect, the invention relates to a device for manually cutting sod around a sprinkler head including a shaft having a first end and a second end, a crank handle coupled to the first end of the shaft, wherein the crank handle comprises a rotatable knob and a U-shaped portion, and a cutting assembly coupled to the second end of the shaft to cut sod.

In another aspect, the invention relates to device for mechanically cutting sod around a sprinkler head including a shaft having a first end and a second end, the first end of the shaft coupled to a drive motor, wherein the drive motor is attached to a mobile transport unit, a cylindrical blade coupled to the second end of the shaft, and an apparatus for lowering the cylindrical blade into the sod and rotating the cylindrical blade for cutting.

In another aspect, the invention relates to a method for manually cutting sod around a sprinkler head, including the steps of providing a sod-cutting tool including a shaft having a first end and a second end, a handle coupled to the first end of the shaft, and a cylindrical blade coupled to the second end of the shaft, positioning the sod-cutting tool over the sprinkler head, inserting the cylindrical blade into the sod, and twisting the handle to cut the sod.

In yet another aspect, the invention relates to a method for mechanically cutting sod around a sprinkler head, the method including the steps of attaching a sod-cutting tool to a mobile transport unit, the sod-cutting tool including a shaft having a first end and a second end, the first end of the shaft coupled to a drive motor, wherein the drive motor is coupled to a mobile transport unit, and a cylindrical blade coupled to the second end of the shaft to cut sod, positioning the sod-cutting tool over the sprinkler head, inserting the cylindrical blade into the sod, and rotating the cylindrical blade with the drive motor to cut the sod.

The above summary of the present invention is not intended to describe each disclosed embodiment or every implementation of the present invention. Figures in the detailed description that follow more particularly exemplify embodiments of the invention. While certain embodiments will be illustrated and describing embodiments of the invention, the invention is not limited to use in such embodiments.

### BRIEF DESCRIPTION OF THE DRAWINGS

The invention may be more completely understood in consideration of the following detailed description of various embodiments of the invention in connection with the accompanying drawings, in which:

FIG. 1 is a schematic front view of an example embodiment of a sod-cutting tool made in accordance with the present invention;

FIG. 2 is a schematic perspective view of the example embodiment of the sod-cutting tool of FIG. 1;

FIG. 3 is a schematic enlarged front view of a portion of the example sod-cutting tool of FIG. 1;

FIG. 4 is a schematic front view of a second example embodiment of a sod-cutting tool made in accordance with the present invention;

FIG. 5 is a schematic side view of a third example embodiment of a sod-cutting tool coupled to a mobile transport unit made in accordance with the present invention; and

FIG. 6 is a schematic top view of the example sod-cutting tool of FIG. 5.

While the invention is amenable to various modifications and alternant forms, specifics thereof have been shown by way of example and the drawings, and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE PREFERRED EMBODIMENTS

The invention is applicable to the maintenance of sod growing on golf courses, parks, residential lawns, or wherever underground sprinklers are used. In particular, the invention is directed to a device for cutting sod that may grow over sprinkler heads. While the present invention is not so limited, an appreciation of the various aspects of the invention will be gained through a discussion of the examples provided below.

As used herein, the term “coupled” means any structure or method that may be used to provide connectivity between two or more elements, which may or may not include a direct physical connection between the elements. As used herein, the term “sod” means any living or dead vegetative growth, including, but not limited to grass, turf, weeds, and/or plants.

I. Sod-Cutting Tools

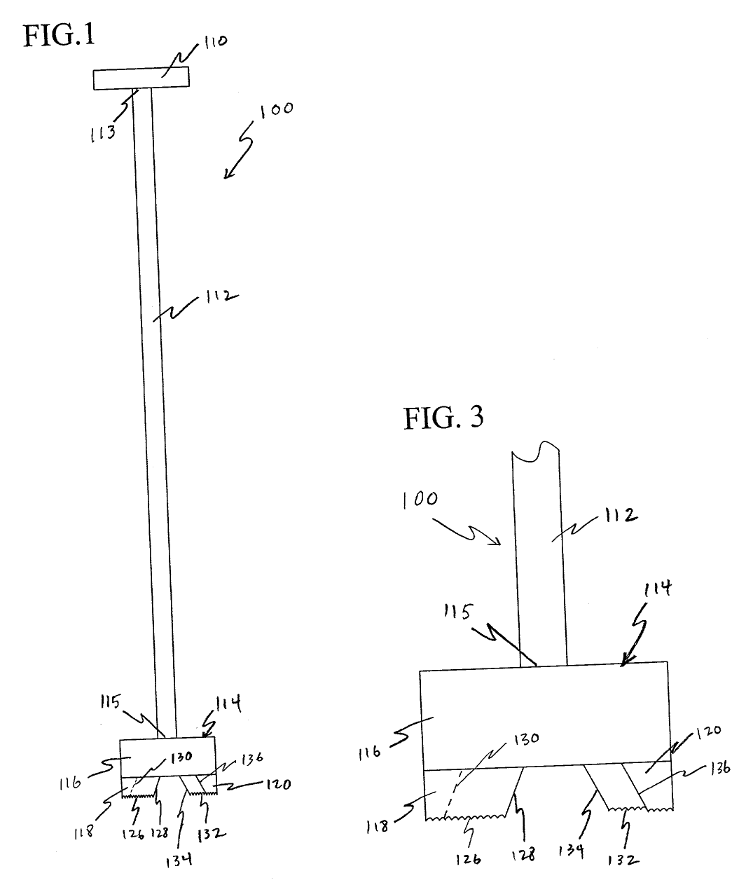

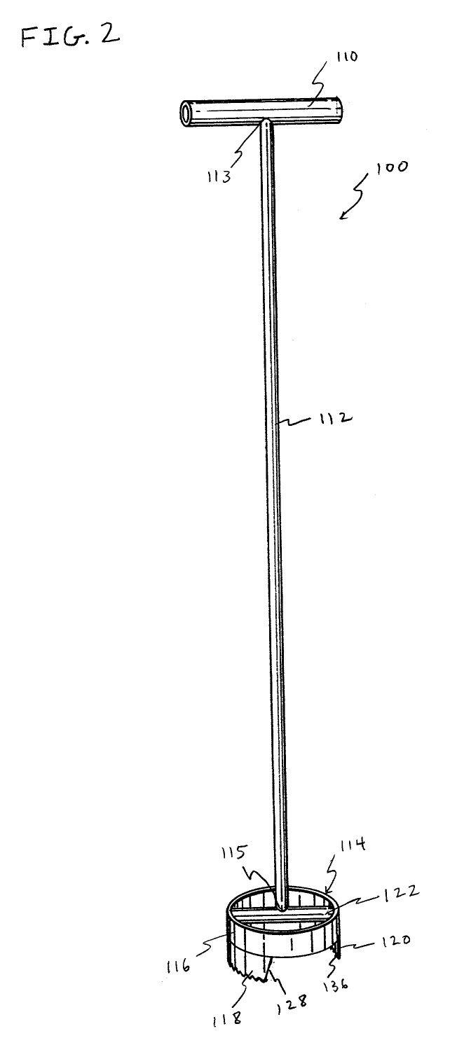

Referring to FIGS. 1 and 2, schematic front and perspective views of an example embodiment of a sod-cutting tool 100 are shown. The sod-cutting tool 100 includes a handle 110 constructed for gripping by a user, a shaft 112, and a cutting assembly 114. The handle 110 and cutting assembly 114 are attached at opposite ends of the shaft 112. The handle 110 is coupled to a first end 113 of the shaft 112. The cutting assembly 114 is attached to a second end 115 of the shaft 112. The handle 110 and cutting assembly 114 can be coupled to the shaft 112 with, for example, screws, bolts, adhesive, a press-fit, or any other suitable means. The shaft 112 can be constructed to any height. Typically, the height of the shaft allows the user to be standing upright and provide the most comfort during use of the sod-cutting tool 100.

The cutting assembly 114 includes a cylindrical portion 116, a first blade 118, a second blade 120, and a linkage element 122. The cylindrical portion 116 is sized larger than a sprinkler head to remove undesirable sod. Preferably, the cylindrical portion 116 can be constructed to be sized approximately one-eighth to three-sixteenths of an inch larger than the sprinkler head requiring removal of sod overgrowth. The cylindrical portion 116 can be constructed to fit around any size of sprinkler head. Alternatively, the cutting assembly can be adjustable to fit over a number of differently sized sprinkler heads. The first blade 118 and second blade 120 are generally of a cylindrical shape that matches the shape of the cylindrical portion 116. Blades 118, 120 are coupled to an inner surface 124 of the cylindrical portion 116, as shown in FIG. 2. Alternatively, the blades and the cylindrical portion can be formed as a single unit or the blades can be attached to an outer surface of the cylindrical portion.

Referring to FIG. 3, an enlarged schematic front view of sod-cutting tool 100 is shown. The first blade 118 includes a bottom edge 126 and first and second side edges 128, 130. Similarly, the second blade 120 includes a bottom edge 132 and first and second side edges 134, 136. Bottom edges 126, 132 can include a serrated shape to aid in the cutting of the sod. Side edges 128, 130, 134 and 136 can be set an angle relative to the axis of rotation of the cutting assembly. Any angle can be used for the side edges. The angle blade can make insertion into and cutting of the sod easier to accomplish. Alternatively, a single blade can be used instead of two blades for the sod-cutting tool, more than two blades can be used for the sod-cutting tool, the bottom edge of the blade can be constructed without a serrated edge, the bottom edge of the blade can be constructed with another type of cutting edge, and the side edges of the blade can be formed without an angle relative to the axis of rotation of the cutting assembly.

The linkage element 122 couples the shaft 112 to the cutting assembly 114. The linkage element 122 can be any portion of the cutting assembly 114 that allows for the connection of the shaft 112. For example, as shown in FIG. 2, the linkage element 122 is a rod type element that is connected to the inner surface 124 of the cylindrical portion 116. Alternatively, the linkage element can be any portion of the cutting assembly that provides a point to couple the shaft to the cutting assembly. For example, the linkage element can be a plate of material that defines a hole through which a screw or bolt is inserted to couple the shaft to the cutting assembly. In this type of construction, the cutting assembly can be formed as a single unit of material.

The linkage element 122 also acts to regulate the depth the cutting assembly 114 and blades 118, 120 are inserted into the sod being cut. A depth of about four inches provides adequate cutting of the sod without damaging objects, such as underground water pipes, located below the surface of the sod. Alternatively, a separate bracket or other regulating device can be attached to the cylindrical portion to regulate the depth of the cut.

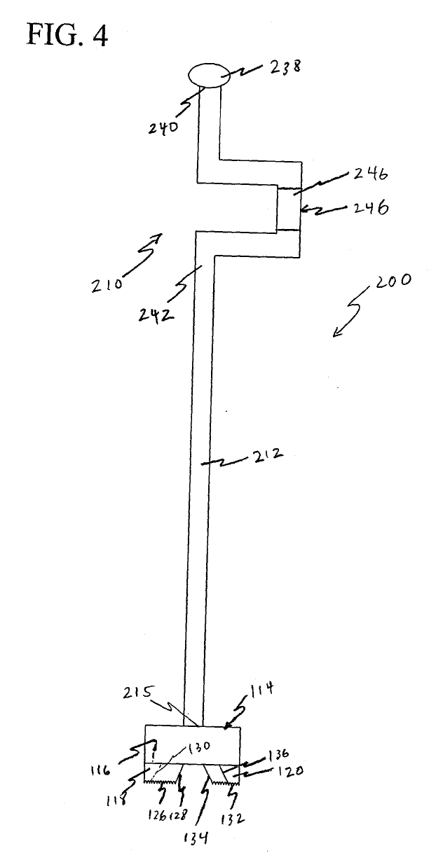

Referring to FIG. 4, a front schematic side view of a second example embodiment of a sod-cutting tool 200 is shown. The sod-cutting tool 200 includes a crank handle 210, a shaft 212, and cutting assembly 114. The crank handle 210 includes a knob 238 attached to a first end 240. The knob 238 is rotatably coupled to the first end 240. The crank handle 210 includes a generally U-shaped portion 244 and a rotatable gripping portion 246. The shaft 212 is connected to a second end 242 of the crank handle 210. Cutting assembly 114 is coupled to a second end 215 of the shaft 212 in a manner similar to the sod-cutting tool 100 embodiment shown in FIGS. 1-3.

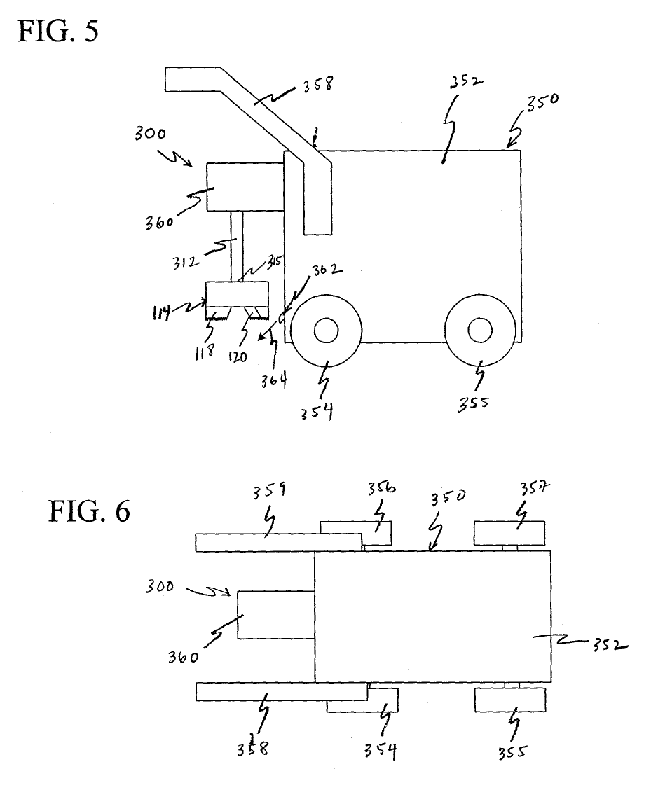

Referring to FIGS. 5 and 6, side and top schematic views of a third embodiment of a sod-cutting tool 300 are shown. The sod-cutting tool 300 is mounted on a mobile transport unit 350. Sod-cutting tool 300 can be mounted on any mobile transport unit, such as, for example, a cart, an all terrain vehicle, a tractor, a car, a truck, or any other moveable device. Mobile transport unit 350 includes a body 352, wheels 354, 355, 356, 357, and handles 358, 359. Body 352 can include a gas motor or battery to power sod-cutting tool 300.

Sod-cutting tool 300 includes a drive motor 358, shaft 312, and cutting assembly 114. Cutting assembly 114 is coupled to a second end 315 of the shaft 312 in a manner similar to sod-cutting tool 100 shown in FIGS. 1-3. The drive motor 360 is coupled to the cutting assembly 114 through the shaft 312.

In some embodiments, sod-cutting tool 300 includes a guide 362 that allows the user of the sod-cutting tool 300 to properly position the cutting assembly 114 over the sprinkler head. For example, a light source, such as a light bulb or laser beam, can be used to direct light, indicated by arrow 364 on FIG. 5, onto the ground to either identify the center point of the cutting assembly or outline a cylindrical cutting shape. Alternatively, mechanical guides can be used to assist in positioning of cutting assembly over a sprinkler head.

II. Operation of the Sod-Cutting Tools

Sod-cutting tool 100 is manually operated by first positioning the cutting assembly 114 over a sprinkler head. After positioning the cutting assembly 114, the user applies downward pressure on the handle 110 to insert blades 118, 120 into the sod. The maximum depth of insertion of the blades 18, 120 is governed by the linkage element 122. The user then twists or rotates the handle 110 to cut the sod.

The twisting or rotation motion of sod-cutting tool 200 is achieved by first solidly gripping knob 238 with one hand without engaging any other portion of the crank handle 210 with that hand. The user then grips rotatable gripping portion 246 with his other hand. The user then twists or rotates the U-shaped portion 244 to cut the sod. The twisting or rotating motion of sod-cutting tools 100, 200 can be clockwise, counterclockwise, or a combination of both motions.

Sod-cutting tool 300 is operated by first moving the mobile transport unit 350 to position the cutting assembly 114 over a sprinkler head. Guide 362 can be used to assist in the positioning of the cutting assembly 114 by shining a light on the area of sod to be cut. After positioning the cutting assembly 114 over the sprinkler head, the user activates the drive motor 360 to lower the cutting assembly 114 to the ground and insert blades 118, 120 into the sod. Optionally, the drive motor 360 limits the depth the blades 118, 120 are inserted into the ground so underground water pipes or other objects located below ground are not damaged. After inserting the blades 118, 120 into the sod, the user activates the drive motor 360 to rotate the shaft 312 and the cutting assembly 114 to cut the sod. The cutting assembly 114 can be rotated in a clockwise, counterclockwise, or a combination of both motions. Following cutting of the sod, the user raises the cutting assembly 114 away from the ground, removing the blades 118, 120 from the sod.

The present invention should not be considered limited to the particular examples or materials described above, but rather should be understood to cover all aspect of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A device for manually cutting sod around a sprinkler head, the device comprising:
a shaft having a first end and second end;
a handle coupled to the first end of the shaft; and
a cutting assembly coupled to the second end of the shaft through a linkage assembly, wherein the cutting assembly comprises a cylinder and a blade configured to cut sod and wherein the linkage assembly regulates a maximum depth of cutting into the sod.

2. The device of claim 1, wherein the blade includes a serrated bottom edge.

3. The device of claim 1, wherein the blade includes a side edge angled relative to the axis of rotation of the cutting assembly.

4. The device of claim 1, wherein the cutting assembly further comprises a second blade.

5. The device of claim 1, wherein the blade has a cylindrical shape.

6. A device for manually cutting sod around a sprinkler head, the device comprising:
a shaft having a first end and a second end;
a handle coupled to the first end of the shaft; and
a cylindrical blade coupled to the second end of the shaft to cut sod wherein the cylindrical blade includes a serrated bottom edge.

7. The device of claim 6, wherein the cylindrical blade includes a side edge angled relative to the axis of rotation of the cylindrical blade.

8. A device for manually cutting sod around a sprinkler head, the device comprising:
a shaft having a first end and a second end;
a crank handle coupled to the first end of the shaft, wherein the crank handle comprises a rotatable knob and a U-shaped portion; and
a cutting assembly coupled to the second end of the shaft to cut sod.

9. The device of claim 8, wherein the blade includes a serrated bottom edge.

10. The device of claim 8, wherein the blade includes a side edge angled relative to the axis of rotation of the cutting assembly.

11. The device of claim 8, wherein the cutting assembly further comprises a second blade.

12. The device of claim 8, wherein the blade has a cylindrical shape.

13. A device for mechanically cutting sod around a sprinkler head, the device comprising:
a shaft having a first end and a second end;
the first end of the shaft coupled to a drive motor, wherein the drive motor is attached to a mobile transport unit;
a cylindrical blade coupled to the second end of the shaft; and
an apparatus for lowering the cylindrical blade into the sod and rotating the cylindrical blade for cutting.

14. The device of claim 13, further comprising a guide configured to project light upon the ground and position the cylindrical blade for cutting sod.

15. A method for manually cutting sod around a sprinkler head, the method comprising the steps of:
providing a sod-cutting tool comprising:
a shaft having a first end and a second end,
a handle coupled to the first end of the shaft, and
a cylindrical blade coupled to the second end of the shaft;
positioning the sod-cutting tool over the sprinkler head;
inserting the cylindrical blade into the sod; and
twisting the handle to cut the sod.

16. A method for mechanically cutting sod around a sprinkler head, the method comprising the steps of:
attaching a sod-cutting tool to a mobile transport unit, the sod-cutting tool comprising:
a shaft having a first end and a second end,
the first end of the shaft coupled to a drive motor, wherein the drive motor is coupled to a mobile transport unit, and
a cylindrical blade coupled to the second end of the shaft to cut sod;
positioning the sod-cutting tool over the sprinkler head;
inserting the cylindrical blade into the sod; and
rotating the cylindrical blade with the drive motor to cut the sod.

17. The method of claim 16, wherein the step of positioning the sod-cutting tool over the sprinkler head comprises the step of projecting light upon the ground to guide the cylindrical blade into a desired position.
